(19) United States
(12) Patent Application Publication
(10) Pub. No.: US 2015/0212658 A1
(43) Pub. Date: Jul. 30, 2015

(54) INDICATING ALTERED USER INTERFACE ELEMENTS

(71) Applicant: LENOVO ENTERPRISE SOLUTIONS (SINGAPORE) PTE. LTD., SINGAPORE (SG)

(72) Inventors: Gary D. Cudak, Creedmoor, NC (US); Luis J. Flores, Houston, TX (US); Christopher J. Hardee, Raleigh, NC (US); Xiaoli Shi, Chapel Hill, NC (US)

(21) Appl. No.: 14/163,847

(22) Filed: Jan. 24, 2014

(51) Int. Cl. G06F 3/0482; G06F 3/0484; G06F 3/16

(52) U.S. Cl. CPC G06F 3/0482; G06F 3/167; G06F 3/0484

(57) ABSTRACT

In an approach for altering interaction with user interface elements, a computer determines a location of one or more elements in a first user interface layout. The computer compares the location of the one or more elements in a second user interface layout. The computer determines the location of at least one of the one or more elements changed in the second user interface layout. The computer determines whether an objective of the change of location is to cause a user to select an alternate element of the one or more elements in the second user interface layout. Responsive to determining the objective of the change of location is to cause a user to select an alternate element of the one or more elements in the second user interface layout, the computer indicates at least one of the one or more elements is altered.

### FIELD OF THE INVENTION

The present invention relates generally to the field of user interface development, and more particularly to alerting users to an altered user interface.

### BACKGROUND OF THE INVENTION

As the World Wide Web grows, so do the dangers exposed to computer users and computing devices. These dangers come in many forms from viruses and malware adapted to disable computers; to spyware, adware, and programs adapted to track and steal personal information; to spam, junk mail, and programs designed to invade the user experience for commercial purposes. There are several solutions provided to detect and remove such software from a computer device, and there are firewalls and browser settings meant to prevent certain interactions. However, there exists a need to provide enhanced security for users of computer devices.

The Internet includes a large number of computers, computer systems, and computer networks that are interconnected through communication channels. Because it facilitates electronic communications between vendors and purchasers, the Internet is increasingly being used to conduct “electronic commerce.” Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. Although many of the commercial transactions that are performed today could be performed via electronic commerce, the acceptance and widespread use of electronic commerce depends, in large part, upon the security and ease-of-use of conducting such electronic commerce.

### SUMMARY

Embodiments of the present invention disclose a method, computer program product, and system for altering interaction with user interface elements. The method includes a computer determining a location of one or more elements in a first user interface layout, wherein a user selects a first element of the one or more elements in the first user interface layout. The computer compares the location of the one or more elements in a second user interface layout. The computer determines the location of at least one of the one or more elements changed in the second user interface layout. The computer determines, based on the change of location of at least one of the one or more elements, whether an objective of the change of location is to cause a user to select an alternate element of the one or more elements in the second user interface layout. Responsive to determining the objective of the change of location is to cause a user to select an alternate element of the one or more elements in the second user interface layout, the computer indicates at least one of the one or more elements is altered.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a depiction of a transaction process that occurs within the data processing environment of FIG. 1, in accordance with an embodiment of the present invention.

FIG. 3 is a flowchart depicting operational steps of one implementation of an element interaction program, on a client computing device within the data processing environment of FIG. 1, for indicating elements are altered in a user interface, in accordance with an embodiment of the present invention.

FIG. 4 depicts a block diagram of components of the client computing device of FIG. 1, in accordance with an embodiment of the present invention.

### DETAILED DESCRIPTION

As a computer user follows a transaction process, the process often requires the user to input selections to indicate decisions, authoritative actions, and/or permissions to facilitate the progression of the transaction. These selections can be made by the user choosing an interactive element designated as a decision input element, such as a YES or NO button, on a graphical user interface (GUI). In general, if the positions of the YES and NO buttons are consistent, a user learns the relative positions of the YES and NO buttons, and may continue to choose the same button based on the learned position, not by reading the words. Many companies try to have users accept terms or contracts by cleverly reversing the position of the YES and NO buttons at various points in the process. Also, some GUI changes occur due to updates in releases or software code fixes, which alter the placement of controls which infer some form of acceptance.

Embodiments of the present invention recognize unwanted transactions could be avoided if a user was alerted to the change in position of the decision input elements. Embodiments of the present invention recognize a change in position of the decision input elements and alert the user that the positions have changed. Implementation of embodiments of the invention may take a variety of forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions, which execute on the computer or other programmable apparatus, provide processes for implementing the functions/acts specified in the flowchart and/or block diagram block or blocks.

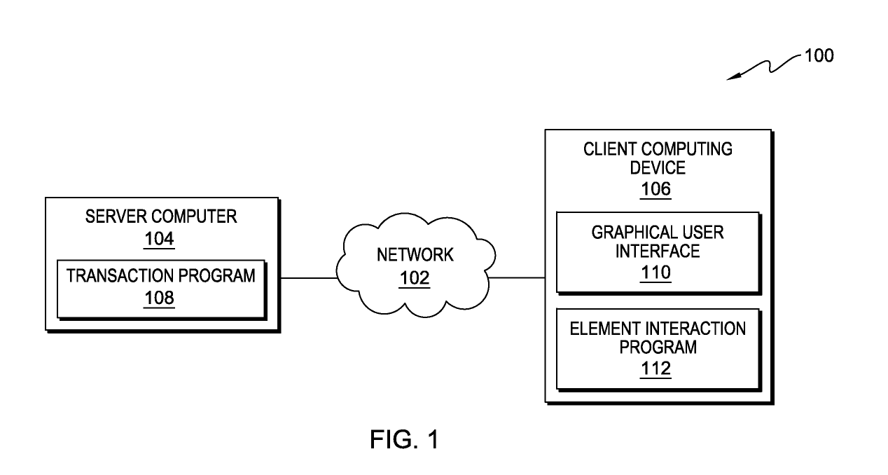

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 106, interconnected over network 102. Network 102 can be, for example, a local area network (LAN), a wide area network (WAN) such as the Internet, or a combination of the two, and can include wired, wireless, or fiber optic connections. In general, network 102 can be any combination of connections and protocols that will support communications between server computer 104 and client computing device 106.

Server computer 104 may be a management server, a web server, or any other electronic device or computing system capable of receiving and sending data. In other embodiments, server computer 104 may represent a server computing system utilizing multiple computers as a server system, such as in a cloud computing environment. In another embodiment, server computer 104 may be a laptop computer, tablet computer, netbook computer, personal computer (PC), a desktop computer, a personal digital assistant (PDA), a smart phone, or any programmable electronic device capable of communicating with client computing device 106 via network 102. In another embodiment, server computer 104 represents a computing system utilizing clustered computers and components to act as a single pool of seamless resources. Server computer 104 includes transaction program 108.

Transaction program 108 resides on server computer 104. In another embodiment, transaction program 108 may reside on another computer device in distributed data processing environment 100. Transaction program 108 is any program accessed by a user via a graphical user interface over network 102 that performs a transaction. The transaction is any process that requires the user to communicate a decision, for example, by requesting user input. The transaction performed by transaction program 108 may be a financial transaction. For example, a user may access transaction program 108 to purchase a product over the Internet. The transaction performed by transaction program 108 may also be for a user to grant permission or an authoritative action. For example, a user may access transaction program 108 to give permission for personal information to be released to a medical facility. In another embodiment, transaction program 108 may reside on client computing device 106, and may communicate directly with graphical user interface 110 and element interaction program 112 without the need of network 102.

Client computing device 106 may be a desktop computer, a laptop computer, a tablet computer, a specialized computer server, a smart phone, or any programmable electronic device capable of communicating with server computer 104 via network 102 and with various components and devices within distributed data processing environment 100. In general, client computing device 106 represents any programmable electronic device or combination of programmable electronic devices capable of executing machine-readable program instructions and communicating with other computing devices via a network, such as network 102. Client computing device 106 includes graphical user interface 110 and element interaction program 112.

Graphical user interface (GUI) 110 resides on client computing device 106. GUI 110 is a program that provides an interface between a user of client computing device 106 and transaction program 108 via network 102. A graphical user interface (GUI), such as GUI 110, is a type of user interface that allows users to interact with electronic devices through graphical icons and visual indicators, such as secondary notation, as opposed to text-based interfaces, typed command labels or text navigation. In computing, GUIs were introduced in reaction to the perceived steep learning curve of command-line interfaces which require commands to be typed on the keyboard. The actions in GUIs are often performed through direct manipulation of the graphical elements. GUIs use structural and interaction graphical elements to offer a consistent visual language to represent information stored in computers. These elements make it easier for users with few computer skills to work with and use computer software. Structural elements include: window, menus, icons, controls (or widgets), tabs. Interaction elements include: cursor, pointer, selection, adjustment handle. User interfaces use visual conventions to represent the generic information shown. Some conventions are used to build the structure of the static elements on which the user can interact, and define the appearance of the interface.

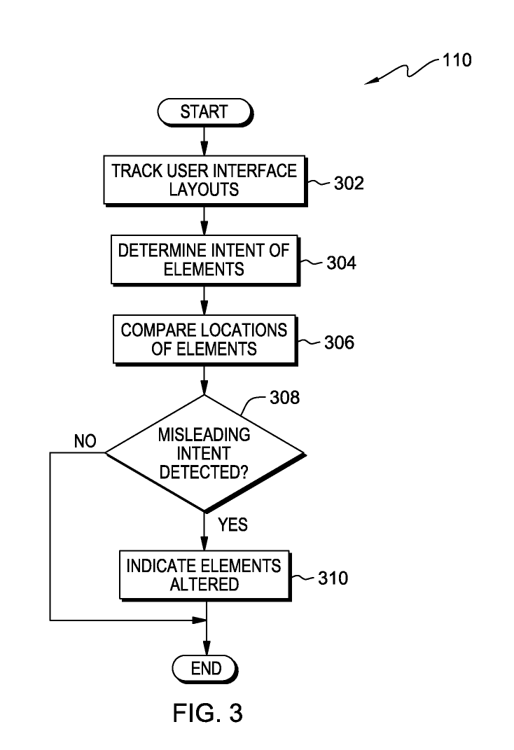

Element interaction program 112 resides on client computing device 106. Element interaction program 112 tracks user interface layouts and determines if transaction program 108 changes the position of decision input elements during the process of a transaction, for example, with the objective of causing the user to select an alternate element in a subsequent user interface layout and thereby misleading the user to unknowingly make an unintended decision. Element interaction program 112 is depicted and described in further detail with respect to FIG. 3.

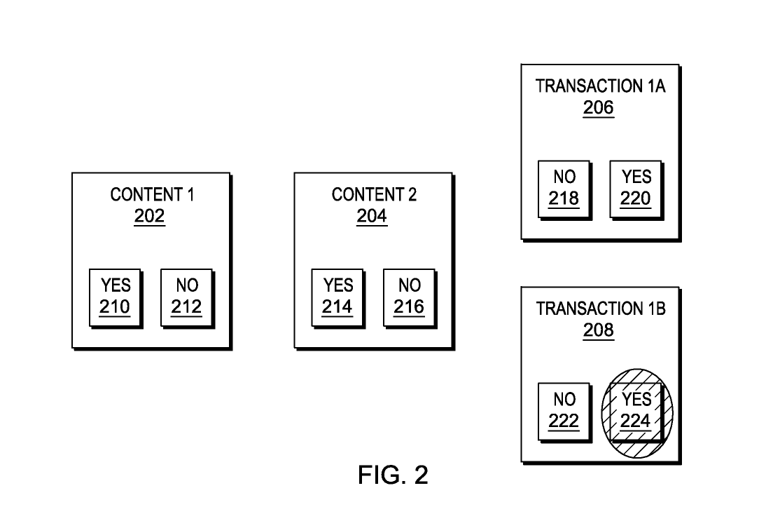

FIG. 2 is a depiction of a transaction process that occurs within distributed data processing environment 100, in accordance with an embodiment of the present invention. The transaction process illustrated by FIG. 2 is a depiction of the interaction between GUI 110 and element interaction program 112 on client computing device 106, and transaction program 108 on server computer 104 via network 102, as shown in FIG. 1. A transaction process can contain many steps and decision points as it progresses. In process box 202, a user reviews content 1 and can make a decision, for example, by clicking on YES button 210 or NO button 212. In another example, the user may choose YES or NO by issuing a voice command. GUI 110 displays YES button 210 on the left side of the screen. GUI 110 displays NO button 212 on the right side of the screen. As the transaction process progresses to process box 204, the user reviews content 2 and can make a decision by clicking on YES button 214 or NO button 216. In the depicted environment, GUI 110 displays the YES and NO buttons in the same positions as the YES and NO buttons of process box 202. The process may continue with additional steps (not shown) in which GUI 110 displays a YES button on the left and a NO button on the right.

Once the transaction process reaches process box 206, transaction 1A occurs. In process box 206, element interaction program 112 is not present on client computing device 106. Transaction program 108 alters the way GUI 110 displays the YES and NO buttons. GUI 110 displays NO button 218 on the left and YES button 220 on the right. These positions are opposite of what they have been during the previous steps of the process. At this point, the user is accustomed to clicking the right side to indicate non-agreement. With the positions reversed, the user may unknowingly choose YES in transaction 1A, giving permission or authority that the user did not intend to convey.

In an embodiment of the present invention, where element interaction program 112 is present on client computing device 106, the transaction process reaches process box 208 instead of process box 206, and transaction 1B occurs. In this example, NO button 222 and YES button 224 are oriented similarly to the orientation shown in process box 206. Element interaction program 112 has detected that the orientation of the YES and NO buttons has changed relative to YES and NO button positions shown earlier in the process. Element interaction program 112 alerts the user to the change in position by altering elements in the user interface, for example, by overlaying a hatched oval on the YES button. Element interaction program 112 may use other means to alert the user, as will be described in further detail with respect to FIG. 3. Since the user is alerted to the change in position of the YES and NO buttons, the user can choose the preferred button.

FIG. 3 is a flowchart depicting operational steps of one implementation of element interaction program 112, on client computing device 106 within data processing environment 100, for indicating elements are altered in a user interface, in accordance with an embodiment of the present invention.

Element interaction program 112 tracks user interface layouts (step 302). As a user progresses through the various steps of a transaction process, element interaction program 112 tracks the layouts of user interface screens and notes the locations of interactive elements. The steps of a transaction process may be represented by a plurality of techniques. For example, a step may be represented by a pop-up screen that appears on a web browser. In other examples, the steps may appear as a new web page or as a slideshow screen. Each element has an x-y location on the screen on which it is displayed, and element interaction program 112 notes the x-y locations of the interactive elements to track the layouts of user interface screens. For example, element interaction program 112 may note that a YES button is located at coordinate (X1, Y1) while a NO button is located at coordinate (X2, Y1). Element interaction program 112 may track the user interface layouts of a transaction program with which the user interfaces many times over weeks or months. For example, element interaction program 112 may track the pop-up ads on a user's mobile phone as they come up on the screen day after day. Element interaction program 112 may also track the user interface layouts of a transaction program with which the user interfaces only once over a matter of minutes. For example, element interaction program 112 may track the user's interaction with a program to purchase a product over the Internet.

Subsequent to tracking user interface layouts, element interaction program 112 determines the objective, or the intent, of the tracked elements (step 304). Element interaction program 112 determines whether the intent of the displayed elements is to request user input by causing the user to make a decision, for example, acceptance or denial of an offer. In one embodiment, element interaction program 112 determines the intent of the tracked elements by taking screen captures and inferring the intent of the words or other visual aspects of the element. For example, element interaction program 112 may look for elements, such as buttons, labeled YES or NO. In another example, element interaction program 112 may look for an element that requests the user enter an “X” or a check mark. This may be done by using text analytics. The term text analytics describes a set of linguistic, statistical, and machine learning techniques that model and structure the information content of textual sources for business intelligence, exploratory data analysis, research, or investigation. In another embodiment, element interaction program 112 may determine the intent of the tracked elements using reflection. Reflection is the ability of code that is running to look at attributes of other elements. Element interaction program 112 may use reflection to look at numerous attributes for a button and determine how similar the button is to another button with more information than simply the button's label.

Subsequent to determining the intent of various elements, element interaction program 112 compares the locations of elements with the intent of causing the user to make a decision (step 306). Element interaction program 112 compares the location of decision input elements during each step of a transaction process and looks for a difference, such as a reversal or significant movement of elements by their intent. The location of a decision input element may be defined as an x-y location, an x-y-z location, or any other means of describing the position of the decision input element. For example, if previously, the x-y locations of a YES and NO button were (X1, Y1) and (X2, Y1), respectively, element interaction program 112 notes when the YES and NO buttons reverse location to (X2, Y1) and (X1, Y1), respectively. In one embodiment, element interaction program 112 uses a pre-defined threshold to compare the x-y location of decision input elements, such as YES and NO buttons, from one screen to another in order to determine whether the movement is significant. For example, a pre-defined threshold may be five coordinate units, and if a decision element moves more than five coordinate units in any direction, element interaction program 112 determines that movement to be significant.

Subsequent to comparing locations of decision input elements, element interaction program 112 determines whether misleading intent has been detected (decision block 308). For example, the detection of misleading intent may be indicated by the reversal of position of YES and NO buttons, causing a user to select an alternate element than on previous user interface layouts in each step of the transaction process. This can be considered misleading when the user has become accustomed to clicking a NO button on the right side of the screen, and chooses YES unknowingly because the YES button has moved to the right side of the screen. In this way, transaction program 108 has misled the user to accept an offer or terms that the user did not intend to accept.

If element interaction program 112 does not detect misleading intent (no branch, decision block 308), then element interaction program 112 ends. If element interaction program 112 does detect misleading intent (yes branch, decision block 308), then element interaction program 112 indicates the elements are altered (step 310). In one embodiment, to alert the user to the potential misleading intent, element interaction program 112 changes the way the user responds to the decision input element. For example, if client computing device 106 has a touch screen for input, element interaction program 112 alters the decision input element to require the user to hold a button down for a longer than usual amount of time in order to confirm the input. In another example, element interaction program 112 may require more than one press of a button, for example, in a particular sequence or pattern. The change in required input draws the attention of the user to note the inference of acceptance or permission by transaction program 108. In yet another example, element interaction program 112 may require the user to perform a completely different input action such as circling the decision input element with the user's finger.

In another embodiment, element interaction program 112 may alter the decision input element by adding a visible cue. For example, if YES and NO buttons have been reversed, element interaction program 112 may display a visible overlay on the YES button, such as a red circle, to call the user's attention to the change in the expected position of the YES button. In another example, element interaction program 112 may display a confirmation question such as “Are you sure you want to choose yes?”

In yet another embodiment, element interaction program 112 may provide an audible cue to alert the user of a potentially misleading element. For example, element interaction program 112 may cause client computing device 106 to emit a loud beep tone when it detects a reversal in position of YES and NO buttons. In another example, if the computing device is a mobile phone with the sound turned off, element interaction program 112 may cause the mobile phone to vibrate in the user's hand to alert the user to a reversal of button positions. Once element interaction program 112 alters the required input, element interaction program 112 ends.

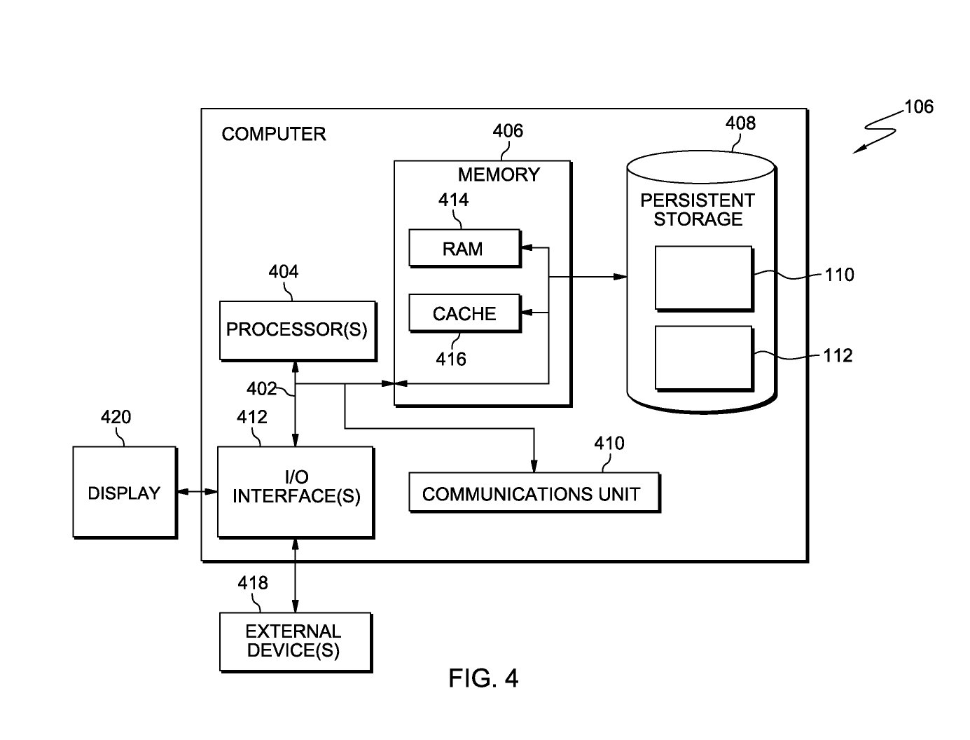

FIG. 4 depicts a block diagram of components of client computing device 106 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Client computing device 106 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Graphical user interface 110 and element interaction program 112 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources server computer 104. In these examples, communications unit 410 includes one or more network interface cards. Communications unit 410 may provide communications through the use of either or both physical and wireless communications links. Graphical user interface 110 and element interaction program 112 may be downloaded to persistent storage 408 through communications unit 410.

I/O interface(s) 412 allows for input and output of data with other devices that may be connected to client computing device 106. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., graphical user interface 110 and element interaction program 112, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for altering interaction with user interface elements, the method comprising:
a computer determining a location of one or more elements in a first user interface layout, wherein a user selects a first element of the one or more elements in the first user interface layout;
the computer comparing the location of the one or more elements in a second user interface layout;
the computer determining the location of at least one of the one or more elements changed in the second user interface layout;
the computer determining, based on the change of location of at least one of the one or more elements, whether an objective of the change of location is to cause a user to select an alternate element of the one or more elements in the second user interface layout; and
responsive to determining the objective of the change of location is to cause a user to select an alternate element of the one or more elements in the second user interface layout, the computer indicating at least one of the one or more elements is altered.

2. The method of claim 1, further comprising the computer determining an objective of the one or more elements, wherein the objective includes requesting a user input.

3. The method of claim 1, wherein comparing the location of the one or more elements in the second user interface layout further comprises:
the computer determining an x-y location of the one or more elements on the first user interface layout;
the computer determining an x-y location of the one or more elements on the second user interface layout; and
the computer determining whether the x-y location of the one or more elements on the second user interface layout is different from the x-y location of the one or more elements on the first user interface layout.

4. The method of claim 3, wherein determining whether the x-y location of the one or more elements on the second user interface layout is different from the x-y location of the one or more elements on the first user interface layout comprises the computer comparing the difference in location to a pre-defined threshold.

5. The method of claim 1, wherein determining the objective of the change of location is to cause a user to select an alternate element of the one or more elements in the second user interface layout comprises the computer determining that the locations of a yes button and a no button from the first user interface layout to the second user interface layout are reversed.

6. The method of claim 1, wherein indicating at least one of the one or more elements is altered comprises the computer overlaying a hatched oval on one of the one or more elements.

7. The method of claim 1, wherein indicating at least one of the one or more elements is altered comprises the computer emitting an audible tone.

8. A computer program product for altering interaction with user interface elements, the computer program product comprising:
one or more computer-readable storage media and program instructions stored on the one or more computer-readable storage media, the program instructions comprising:
program instructions to determine a location of one or more elements in a first user interface layout, wherein a user selects a first element of the one or more elements in the first user interface layout;
program instructions to compare the location of the one or more elements in a second user interface layout;
program instructions to determine the location of at least one of the one or more elements changed in the second user interface layout;
program instructions to determine, based on the change of location of at least one of the one or more elements, whether an objective of the change of location is to cause a user to select an alternate element of the one or more elements in the second user interface layout; and
program instructions to, responsive to determining the objective of the change of location is to cause a user to select an alternate element of the one or more elements in the second user interface layout, indicate at least one of the one or more elements is altered.

9. The computer program product of claim 8, further comprising program instructions to determine an objective of the one or more elements, wherein the objective includes requesting a user input.

10. The computer program product of claim 8, wherein the program instructions to compare the location of the one or more elements in the second user interface layout further comprise:
program instructions to determine an x-y location of the one or more elements on the first user interface layout;
program instructions to determine an x-y location of the one or more elements on the second user interface layout; and
program instructions to determine whether the x-y location of the one or more elements on the second user interface layout is different from the x-y location of the one or more elements on the first user interface layout.

11. The computer program product of claim 10, wherein the program instructions to determine whether the x-y location of the one or more elements on the second user interface layout is different from the x-y location of the one or more elements on the first user interface layout comprises program instructions to compare the difference in location to a pre-defined threshold.

12. The computer program product of claim 8, wherein the program instructions to determine the objective of the change of location is to cause a user to select an alternate element of the one or more elements in the second user interface layout comprises program instructions to determine that the locations of a yes button and a no button from the first user interface layout to the second user interface layout are reversed.

13. The computer program product of claim 8, wherein program instructions to indicate at least one of the one or more elements is altered comprises program instructions to overlay a hatched oval on one of the one or more elements.

14. The computer program product of claim 8, wherein program instructions to indicate at least one of the one or more elements is altered comprises program instructions to emit an audible tone.

15. A computer system for altering interaction with user interface elements, the computer system comprising:
one or more computer processors;
one or more computer-readable storage media;
program instructions stored on the computer-readable storage media for execution by at least one of the one or more processors, the program instructions comprising:
program instructions to determine a location of one or more elements in a first user interface layout, wherein a user selects a first element of the one or more elements in the first user interface layout;
program instructions to compare the location of the one or more elements in a second user interface layout;
program instructions to determine the location of at least one of the one or more elements changed in the second user interface layout;
program instructions to determine, based on the change of location of at least one of the one or more elements, whether an objective of the change of location is to cause a user to select an alternate element of the one or more elements in the second user interface layout; and
program instructions to, responsive to determining the objective of the change of location is to cause a user to select an alternate element of the one or more elements in the second user interface layout, indicate at least one of the one or more elements is altered.

16. The computer system of claim 15, further comprising program instructions to determine an objective of the one or more elements, wherein the objective includes requesting a user input.

17. The computer system of claim 15, wherein the program instructions to compare the location of the one or more elements in the second user interface layout further comprise:
program instructions to determine an x-y location of the one or more elements on the first user interface layout;
program instructions to determine an x-y location of the one or more elements on the second user interface layout; and
program instructions to determine whether the x-y location of the one or more elements on the second user interface layout is different from the x-y location of the one or more elements on the first user interface layout.

18. The computer system of claim 17, wherein the program instructions to determine whether the x-y location of the one or more elements on the second user interface layout is different from the x-y location of the one or more elements on the first user interface layout comprises program instructions to compare the difference in location to a pre-defined threshold.

19. The computer system of claim 15, wherein the program instructions to determine the objective of the change of location is to cause a user to select an alternate element of the one or more elements in the second user interface layout comprises program instructions to determine that the locations of a yes button and a no button from the first user interface layout to the second user interface layout are reversed.

20. The computer system of claim 15, wherein program instructions to indicate at least one of the one or more elements is altered comprises program instructions to overlay a hatched oval on one of the one or more elements.
